(19) United States
(12) Patent Application Publication
(10) Pub. No.: US 2024/0177474 A1
(43) Pub. Date: May 30, 2024

(54) SYSTEMS AND METHOD FOR TRANSFORMING INPUT DATA TO PALETTES USING NEURAL NETWORKS

(71) Applicant: Perception Systems, LLC, Irvine, CA (US)

(72) Inventors: Mitchell Pudil, Bountiful, UT (US); Michael Blum, Bountiful, UT (US); Jamison Moody, Provo, UT (US); Michael Henry Merchant, Rancho Santa Margarita, CA (US); Danny Petrovich, La Habra Height, CA (US)

(21) Appl. No.: 18/521,263

(22) Filed: Nov. 28, 2023

Related U.S. Application Data
(60) Provisional application No. 63/385,176, filed on Nov. 28, 2022.

(51) Int. Cl. G06V 10/82; G06F 40/205; G06F 40/289; G06V 10/56; G06V 10/77

(52) U.S. Cl. CPC G06V 10/82; G06F 40/205; G06F 40/289; G06V 10/56; G06V 10/7715

(57) ABSTRACT

A device to represent an image with a palette is disclosed. The device includes a processor, a memory communicatively coupled to the processor, and a logic. The logic includes a neural network to receive an input data to generate prediction data. The neural network includes a multi-step convolution pathway including a plurality of convolution steps, and a multi-step upsampling pathway including a plurality of upsampling steps. The plurality of upsampling steps includes an input to receive output data from a corresponding convolution pathway step. In response to receiving the input data, feature map output data is generated at the plurality of convolution steps, and at least one step of the plurality of upsampling steps utilizes at least the generated feature map data to generate prediction data. The neural network extracts one or more features from the input data, and generate the prediction data based on the one or more features.

### PRIORITY

This application claims the benefit of and priority to U.S. Provisional Application, entitled “Systems and Method For Transforming Input Data To Palettes Using Neural Networks,” filed on Nov. 28, 2022 and having application Ser. No. 63/385,176.

### FIELD

The present disclosure relates to data processing systems. More particularly, the present disclosure relates to representing an input data by a palette by associating the input data with a high-dimensional vector performed by neural network algorithms.

### BACKGROUND

Current image recognition techniques often output a class label for an identified object, and image segmentation techniques often create a pixel-level understanding of a scene's elements. Commercial brands and other users are often competing to have an upper hand against their competitors. On the one hand, businesses spend heavily to design brands and logos that are appealing to their customers and make them various emotions (such as “feeling good”) about the brand or user. On the other hand, changing color schemes of brands can be expensive, so picking the wrong colors in the brands that are associated with or generate negative responses can cause headaches to the business owners and/or users.

### SUMMARY

In many embodiments, a device includes a processor, a memory communicatively coupled to the processor, and a logic. The logic can include a neural network that can receive an input data to generate prediction data. The neural network can include a multi-step convolution pathway including a plurality of convolution steps, and a multi-step upsampling pathway including a plurality of upsampling steps. The plurality of upsampling steps can include an input to receive output data from a corresponding convolution pathway step. In response to receiving the input data, feature map output data can be generated at the plurality of convolution steps, and at least one step of the plurality of upsampling steps can utilize at least the generated feature map data to generate the prediction data. The neural network can further extract one or more features from the input data, and generate the prediction data based on the extracted one or more features.

In some embodiments, the input data can be an image and can be received from a user. The neural network can display the generated prediction data to the user. The neural network can further identify one or more objects in the image, determine one or more colors for each identified object, calculate a set of overall areas comprising the one or more determined colors, and generate a palette based on the calculated set of overall areas.

The neural network can be configured to generate a vector associated with each of the one or more colors. A length of the vector can be indicative of a cross section of an area comprising each of the one or more colors. The neural network can calculate the set of overall areas by adding lengths of each generated vector.

The neural network can further be configured to calculate a first overall vector associated with the image based on a vector summation of the set of overall areas, calculate a vector summation for the palette, and store the palette in response to a first determination that a first closeness ratio associated with the palette is larger than a first pre-determined threshold. The first closeness ratio can be defined as an inverse of a difference between the calculated vector summation of the palette and the calculated first overall vector.

In some embodiments, the input data can be a phrase. In such embodiments, the neural network can be configured to identify one or more words in the phrase, generate a set of vectors associated with each identified words, calculate a second overall vector associated with the received phrase based on a vector summation of the generated set of vectors, generate a palette for a set of colors comprising a predefined number of colors, calculate a third overall vector associated with the palette based on a vector summation of the set of colors, and store the palette in response to a second determination that a second closeness ratio associated with the generated palette is larger than a second pre-determined threshold. The second closeness ratio can be defined as an inverse of a difference between the calculated second overall vector and the calculated third overall vector. In some embodiments, the user selects the predefined number of colors.

The neural network can be configured to access a database including pairs of colors and corresponding adjectives, and determine an adjective for each of the set of colors of the generated palette. The neural network can further parse the received phrase to identify a set of words, assign a weight to each of the identified words. The assigned weight can be a number between 0 and 1. The neural network can be configured to generate a second set of vectors associated with each of the identified words, calculate a set of weighted vectors by applying the assigned weight to the associated identified word, and calculate a fourth overall vector associated with the identified set of words based on the vector summation of the calculated set of weighted vectors.

In some embodiments, in response to a third determination that a third closeness ratio associated with the generated palette is larger than a third pre-determined threshold, the neural network can be configured to store the generated palette. The third closeness ratio can be defined as an inverse of a difference between the calculated third overall vector and the calculated fourth overall vector. The user can select the assigned weights.

According to another aspect of the present disclosure, a method to represent an input data with a palette is disclosed. The method can include configuring a neural network to receive input data to generate prediction data, establishing a multi-step convolution including a plurality of convolution steps, establishing a multi-step upsampling pathway including a plurality of upsampling steps. The plurality of upsampling steps can include an input to receive output data from a corresponding convolution pathway step. In response to receiving the input data feature map output data can be generated at the plurality of convolution steps, and at least one step of the plurality of upsampling steps can utilize at least the generated feature map data to generate prediction data. The neural network can further extract one or more features from the input data, and generate the prediction data based on the extracted one or more features.

In some embodiments, the method can include configuring the neural network to identify one or more objects in the input data, determine one or more colors for each identified object, calculate a set of overall areas comprising the one or more determined colors, and generate a palette based on the calculated set of overall areas. The input data can be an image.

In some embodiments, the method can include configuring the neural network to generate a vector associated with each of the one or more colors, and calculate the set of overall areas by adding lengths of each generated vector. A length of the vector can be indicative of a cross-section an area comprising each of the one or more colors.

In some embodiments, the method can include configuring the neural network to calculate a first overall vector associated with the image based on a vector summation of the set of overall areas, calculate a vector summation for the palette, and in response to a first determination that a first closeness ratio associated with the palette is larger than a first pre-determined threshold, store the palette. The first closeness ratio can be defined as an inverse of a difference between the calculated vector summation of the palette and the calculated first overall vector.

The method can further include configuring the neural network to receive the input data comprising a phrase, identify one or more words in the phrase, generate a set of vectors associated with each identified words, calculate a second overall vector associated with the received phrase based on a vector summation of the generated set of vectors, generate a palette for a set of colors including a predefined number of colors, calculate a third overall vector associated with the palette based on a vector summation of the set of colors, and in response to a second determination that a second closeness ratio associated with the generated palette is larger than a second pre-determined threshold, store the generated palette. The second closeness ratio can be defined as an inverse of a difference between the calculated second overall vector and the calculated third overall vector.

The method can include configuring the neural network to assign a weight to each of the identified words, generate a second set of vectors associated with each of the identified words, calculate a set of weighted vectors by applying the assigned weight to the associated identified word and calculate a fourth overall vector associated with the identified set of words based on the vector summation of the calculated set of weighted vectors. The assigned weight can be a number between 0 and 1.

According to yet another aspect of the present disclosure, an input data to palette transformation system is disclosed. The system can include one or more devices, one or more processors coupled to the one or devices, and a non-transitory computer-readable storage medium including a neural network that can receive an input data to generate prediction data. The neural network can include a multi-step convolution pathway including a plurality of convolution steps, and a multi-step upsampling pathway including a plurality of upsampling steps. The plurality of upsampling steps can include an input to receive output data from a corresponding convolution pathway step. In response to receiving the input data, feature map output data can be generated at the plurality of convolution steps, and at least one step of the plurality of upsampling steps can utilize at least the generated feature map data to generate prediction data. The neural network can further extract one or more features from the input data, and generate the prediction data based on the extracted one or more features.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual diagram of a system for transforming input data to palettes using neural networks in accordance with an embodiment of the disclosure;

FIG. 2 is conceptual illustration of a neural network in accordance with an embodiment of the disclosure;

FIG. 3 is a conceptual illustration of a convolution process in accordance with an embodiment of the disclosure;

FIG. 4A is an illustrative visual example of a convolution process in a neural network capable of performing the operations to transform input data to palette in accordance with an embodiment of the disclosure;

FIG. 4B is an illustrative numerical example of a convolution process performed in a neural network capable of performing the operations to transform input data to palette in accordance with an embodiment of the disclosure;

FIG. 5A is an illustrative visual example of an upsampling process in a neural network capable of performing the operations to transform input data to palette in accordance with an embodiment of the disclosure;

FIG. 5B is an illustrative numerical example of an upsampling process in a neural network capable of performing the operations to transform input data to palette in accordance with an embodiment of the disclosure;

FIG. 5C is an illustrative numerical example of a second upsampling process in a neural network capable of performing the operations to transform input data to palette in accordance with an embodiment of the disclosure;

FIG. 5 D is an illustrative numerical example of an upsampling process with a second input for unpooling in a neural network capable of performing the operations to transform input data to palette in accordance with an embodiment of the disclosure;

FIG. 6A is conceptual illustration of a feature pyramid network in accordance with an embodiment of the disclosure;

FIG. 6B is a conceptual diagram of a system for transforming input data to palettes using neural network in accordance with an embodiment of the disclosure;

FIG. 7 is conceptual diagram of a set of adjectives-palette pairs generated by the logic in accordance with an embodiment of the disclosure;

FIG. 8 is a flowchart depicting a process for generating a palette for an input data in accordance with an embodiment of the disclosure;

FIG. 9 is a flowchart depicting a process for calculating a vector summation for an input data in accordance with an embodiments of the disclosure;

FIG. 10 is a conceptual diagram of a device configured to utilize an image to palette representation logic in accordance with various embodiments of the disclosure; and

FIG. 11 is a conceptual network diagram of various environments that an image to palette representation logic may operate within in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems described above, systems and methods are discussed herein that can efficiently represent an input data with a palette including a plurality of colors. A user can input the input data and the system can generate a palette to transform the input data into a palette form. Additionally, in a variety of embodiments, the system can utilize neural networks to achieve the end goal. That is, the neural networks can perform some or all of the steps that described herein. Various neural networks can be used, and the system can train the neural networks to perform such steps in an efficient manner and with enhanced accuracy. In many embodiments, the system can utilize the neural network which is trained to associate the input data with high-dimensional vectors and determine the features to generate the palette based on vector calculations.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

“Neural network” refers to any logic, circuitry, component, chip, die, package, module, system, sub-system, or computing system configured to perform tasks by imitating biological neural networks of people or animals. Neural network, as used herein, may also be referred to as an artificial neural network (ANN). Examples of neural networks that may be used with various embodiments of the disclosed solution include, but are not limited to, convolutional neural networks, feed forward neural networks, radial basis neural network, recurrent neural networks, modular neural networks, and the like. Certain neural networks may be designed for specific tasks such as object detection, natural language processing (NLP), natural language generation (NLG), and the like. Examples of neural networks suitable for object detection include, but are not limited to, Region-based Convolutional Neural Network (RCNN), Spatial Pyramid Pooling (SPP-net), Fast Region-based Convolutional Neural Network (Fast R-CNN), Faster Region-based Convolutional Neural Network (Faster R-CNN), You Only Look Once (YOLO), Single Shot Detector (SSD), and the like.

A neural network may include both the logic, software, firmware, and/or circuitry for implementing the neural network as well as the data and metadata for operating the neural network. One or more of these components for a neural network may be embodied in one or more of a variety of repositories, including in one or more files, databases, folders, or the like. The neural network used with embodiments disclosed herein may employ one or more of a variety of learning models including, but not limited to, supervised learning, unsupervised learning, and reinforcement learning. These learning models may employ various backpropagation techniques.

Functions or other computer-based instructions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C. or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to”, unless expressly specified otherwise. An enumerated listing of items does not imply that any or all of the items are mutually exclusive and/or mutually inclusive, unless expressly specified otherwise. The terms “a.” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

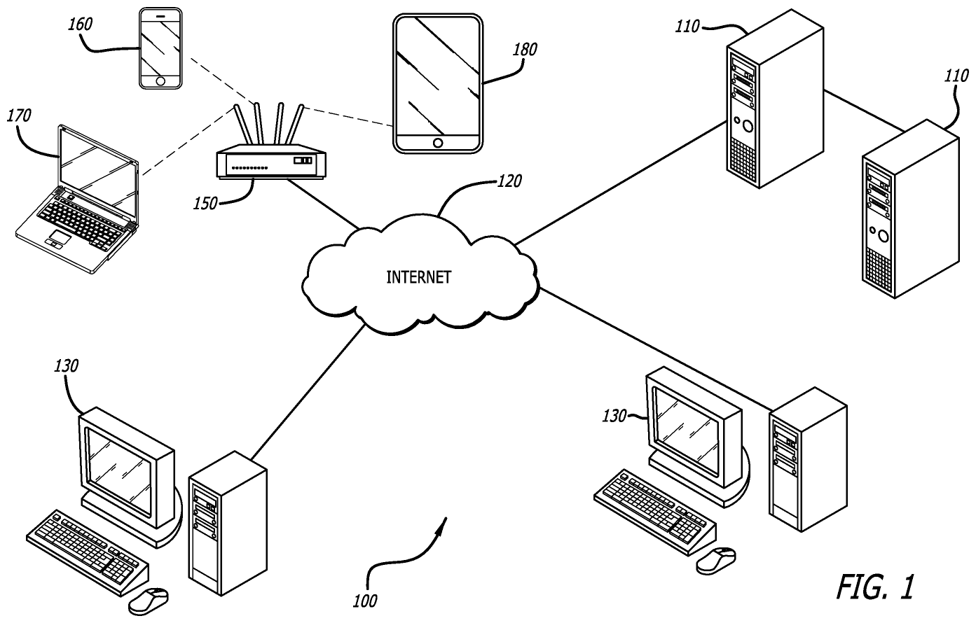

Referring to FIG. 1, a conceptual diagram of a system for transforming input data to palettes using neural network 100 in accordance with an embodiment of the disclosure is shown. The system for transforming input data to palettes using neural network 100 can include a plurality of devices that are configured to transmit and receive data that can be processed to be represented by a palette. In many embodiments, computing devices 110 are connected to a network 120 such as, for example, the Internet. The computing devices 110 are configured to receive a variety of data across the network 120 from any number of other computing devices such as, but not limited to, personal computers 130 and mobile computing devices including laptop computers 170, cellular phones 160 and portable tablet computers 180. In additional embodiments, the computing devices 110 can be hosted as virtual servers within a cloud-based service. In further embodiments, the sending and receiving of data can occur over the network 120 through wired and/or wireless connections. In the embodiment depicted in FIG. 1, the mobile computing devices 160, 170, 180 are connected wirelessly to the network 120 via a wireless network access point 150. It should be understood by those skilled in the art that the types of wired and/or wireless connections between devices on the system for transforming input data to palettes using neural network 100 can be comprised of any combination of devices and connections as needed.

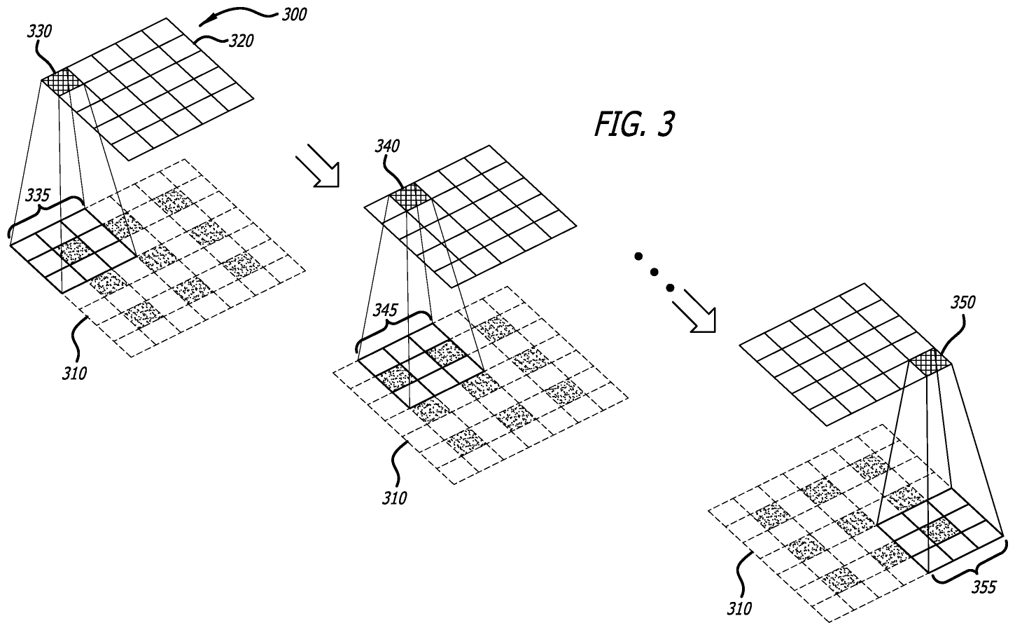

In various embodiments, the system for transforming input data to palettes using neural networks can utilize one or more neural networks to perform any of the steps of the operations and steps disclosed herein. A detailed description of an exemplary neural network that can perform at least parts of the disclosed methods is provided below. While for sake of simplicity an image is illustrated as an input data in FIGS. 3-6A, it will be understood that the input data can be any other data format, such as a word or a textual phrase.

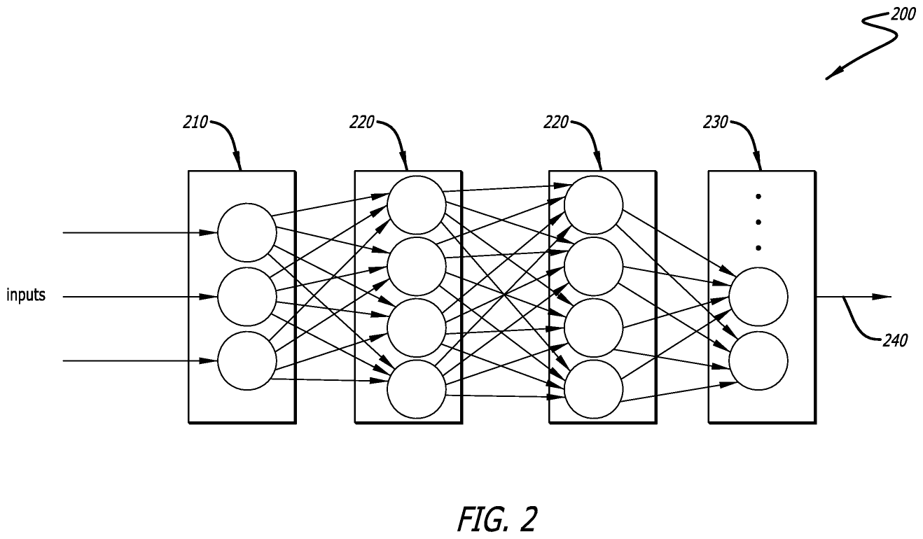

Although a specific embodiment for a system for transforming input data to palettes using neural networks suitable for carrying out the various steps, processes, methods, and operations described herein is discussed with respect to FIG. 1, any of a variety of systems and/or processes may be utilized in accordance with embodiments of the disclosure. For example, the image to palette representation logic may be implemented across a variety of the systems described herein such that some representations are generated on a first system type (e.g., remotely), while additional steps or actions are generated or determined in a second system type (e.g., locally). The elements depicted in FIG. 1 may also be interchangeable with other elements of FIGS. 2-11 as required to realize a particularly desired embodiment.

Referring to FIG. 2, is a conceptual illustration of a neural network capable of performing the operations to transform input data to palette in accordance with an embodiment of the disclosure is shown. The neural network illustrated in FIGS. 3-6A can operate within the system for transforming input data to palettes using neural network 100 as depicted in FIG. 1. For sake of simplicity, FIGS. 3-6A only depict the neural networks and its components and stages and the remaining components of the system for transforming input data to palettes using neural network 100 are not shown. However, it is understood that any such neural networks as shown in FIGS. 3-6A and described in the following paragraphs can be part of the system for transforming input data to palettes using neural network 200.

At a high level, the neural network capable of performing the operations to transform input data to palette 240 can include an input layer 210, at least two hidden layers 220, and an output layer 230. As noted above, the neural network depicted in FIG. 2 is shown as an illustrative example and various embodiments may include neural networks that can accept more than one type input and can provide more than one type of output. In an embodiment, a signal at a connection between artificial neurons can be a real number, and the output of each artificial neuron can be computed by some non-linear function (hereinafter “activation function”) of the sum of the artificial neuron's inputs. The connections between artificial neurons are called edges. Artificial neurons and edges can have a weight that adjusts as learning proceeds. The weight can increase or decrease the strength of the signal at a connection. Artificial neurons may have a threshold (hereinafter “trigger threshold”) such that the signal is only sent if the aggregate signal crosses that threshold. In various embodiments, artificial neurons are aggregated into layers. Different layers may perform different kinds of transformations on their inputs. Signals can propagate from the first layer (the input layer 210), to the last layer (the output layer 230), possibly after traversing one or more intermediate layers 220.

In case of an image as the input data, the inputs to the neural network capable of performing the operations to transform input data to palette may be data representing pixel values for certain pixels within the image. In one embodiment, the neural network 200 can include a series of hidden layers in which each neuron is fully connected to neurons of the next layer. The last layer in the neural network may implement a regression function to produce the classified or predicted classifications for object detection as output (such as palette 240). In certain embodiments, the neural network 200 can be trained prior to deployment and to conserve operational resources. However, some embodiments may utilize ongoing training of the neural network 200. The neural networks can process input data through a series of downsamplings (e.g. convolutions, pooling, etc.) and upsamplings (i.e. expansions) to generate an inference map.

Although a specific embodiment for a neural network suitable for carrying out the various steps, processes, methods, and operations described herein is discussed with respect to FIG. 2, any of a variety of systems and/or processes may be utilized in accordance with embodiments of the disclosure. For example, the neural network may be processed locally or remotely by a third-party or cloud-based service. The elements depicted in FIG. 2 may also be interchangeable with other elements of FIGS. 1-2 and 4-11 as required to realize a particularly desired embodiment.

Referring to FIG. 3, a conceptual illustration of a convolution process 300 associated with a neural network capable of performing the operations to transform input data to palette in accordance with an embodiment of the disclosure is shown. In some embodiments, input data is processed through one or more convolution layers which will add each element of the image to its local neighbors, weighted by a kernel. As an illustrative example, FIG. 3 depicts a simplified convolution process 300 on an array of pixels within an image 310 to generate a feature map 320. The exemplary image 310 depicted in FIG. 3 is comprised of forty-nine pixels in a seven-by-seven array. However, any image size may be processed in this manner and the size depicted in this figure is minimized to better convey the overall process utilized. In the first step within the process 300, a first portion 335 of the image 310 is processed. The first portion 335 can include a three-by-three array of pixels. This first portion is processed through a filter to generate an output pixel 330 within the feature map 320. The filter can be another array, matrix, or mathematical operation that can be processed on the portion being processed. In some embodiments, the filter can be presented as a matrix similar to the portion being processed and generates the output feature map portion via matrix multiplication or similar operation. Alternatively, the filter may be a heuristic rule that applies to the portion being processed. The process 300 can then analyze a second (or next) portion 345 of the image 310. This second portion 345 is again processed through a filter to generate a second output pixel 340 within the feature map. This method can be similar to, or different from, the method utilized to generate the first output pixel 330. The process 300 continues in a similar fashion until the last portion 355 of the image 310 is processed by the filter to generate a last output pixel 350.

Although a conceptual diagram of a convolution process suitable for carrying out the various steps, processes, methods, and operations described herein is discussed with respect to FIG. 3, any of a variety of systems and/or processes may be utilized in accordance with embodiments of the disclosure. For example, the convolution can be carried out over image data or other numerical data in a method similar to that described in FIG. 3. The elements depicted in FIG. 3 may also be interchangeable with other elements of FIGS. 1-2 and 4A-11 as required to realize a particularly desired embodiment.

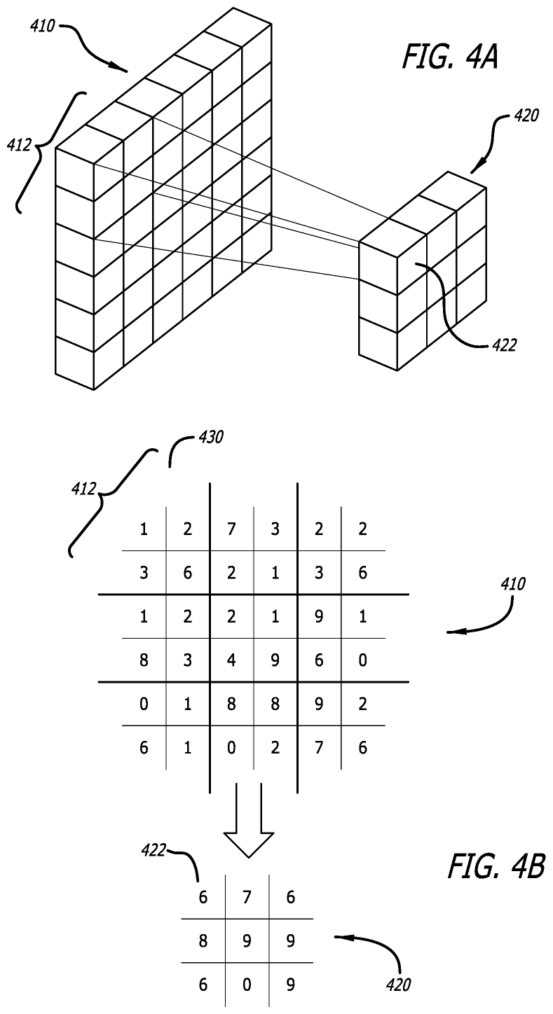

Referring to FIG. 4A, an illustrative visual example of a convolution process in a neural network capable of performing the operations to transform input data to palette in accordance with an embodiment of the disclosure is shown. As discussed above, the convolution process can take an input set of data, process that data through a filter, and generate an output that can be smaller than the input data. In various embodiments, padding may be added during the processing to generate output that is similar or larger than the input data. An example visual representation of a data block 410 highlights this processing of data from a first form to a second form. The data block 410 can comprise a first portion 412 which is processed through a filter to generate a first output feature map data block 422 within the output feature map 420.

Referring to FIG. 4B, an illustrative numerical example of a convolution process performed in a neural network capable of performing the operations to transform input data to palette in accordance with an embodiment of the disclosure is shown. Again, the data block 410 is shown numerically processed into an output feature map 420. The first portion 412 is a two by two numerical matrix in the upper left corner of the data block 410. The convolution process examines those first portion 412 matrix values through a filter. The can apply a heuristic rule to output the maximum value within the processed portion, thus, the first portion 412 results in a feature map data block 422 value of five. The remaining two by two sub-matrices within the data block 410 can comprise at least one highlighted value that corresponds to the maximum value within that matrix and is thus the resultant feature map block output within the feature map 420. In an embodiment, the convolution process can be applied every two data blocks (or sub-matrix) whereas in another embodiment, the convolution process can progress pixel by pixel. Thus, the convolution processes can progress at various units, within various dimensions, and with various sizes. It should be noted that, as input data becomes larger and more complex, the filters applied to the input data can also become more complex to create output feature maps that can indicate various aspects of the input data. These aspects can include, but are not limited to, straight lines, edges, curves, color changes, boundaries, etc.

Although illustrative examples of the convolution process suitable for carrying out the various steps, processes, methods, and operations described herein is discussed with respect to FIGS. 4A-4B, any of a variety of systems and/or processes may be utilized in accordance with embodiments of the disclosure. For example, the convolution process can be carried out locally or remotely on a cloud-based service or the like. The elements depicted in FIGS. 4A-4B may also be interchangeable with other elements of FIGS. 1-3 and 5A-11 as required to realize a particularly desired embodiment.

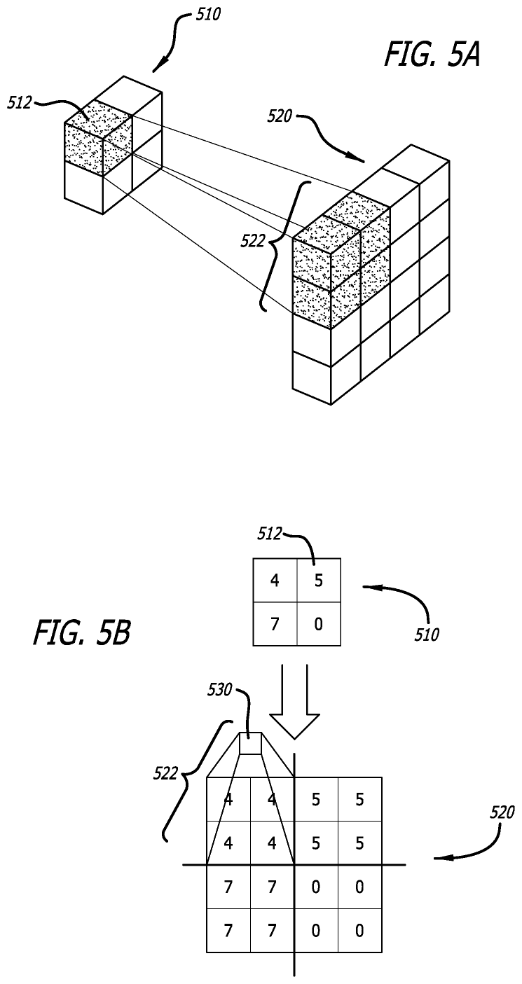

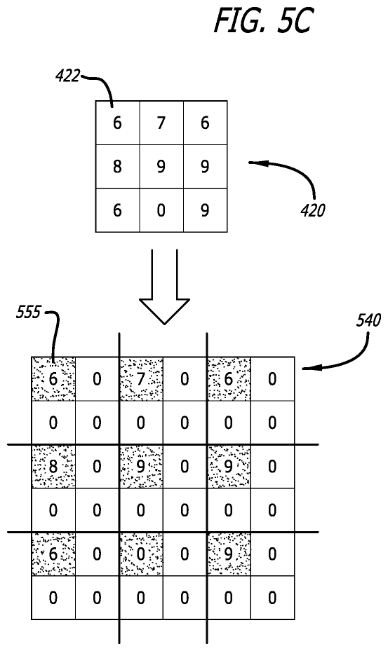

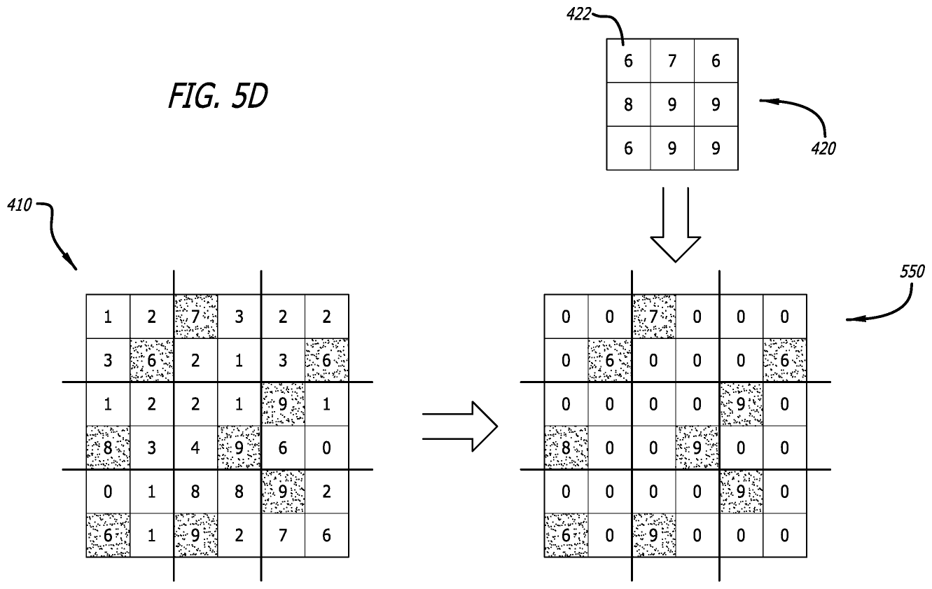

Referring to FIG. 5A, an illustrative visual example of an upsampling process in a neural network capable of performing the operations to transform input data to palette in accordance with an embodiment of the disclosure is shown. The process of upsampling is similar to the convolution process wherein an input is processed through a filter to generate an output. The differences are that upsampling typically has an output that is generally larger than the input.

Specifically, referring to FIG. 5B, an illustrative numerical example of an upsampling process in a neural network capable of performing the operations to transform input data to palette in accordance with an embodiment of the disclosure is shown. An input block 522 of the input matrix 520 is processed through a filter 530 to generate an output matrix block 522 within the output matrix 520. In an embodiment, the filter can be a nearest neighbor filter. This process is shown numerically through the example input block 512 which has a value of four being processed through a filter 530 that results in all values within the output matrix block 522 to contain the same value of four. This process can be applied to the remaining input blocks within the input matrix 510 to generate similar output blocks within the output matrix 520 that expand or copy their values to all blocks within their respective output matrix block.

Referring to FIG. 5C, an illustrative numerical example of a second upsampling process in a neural network capable of performing the operations to transform input data to palette in accordance with an embodiment of the disclosure is shown. Although the upsampling process depicted in FIGS. 5A-5B utilize a filter that expands or applies the input value as output values to each respective output block, it should be noted that a variety of upsampling filters may be used including those filters that can apply their values to only partial locations within the output matrix.

As depicted in FIG. 5C, many embodiments of an upsampling process in a neural network capable of performing the operations to transform input data to palette may pass the input value along to only one location within the respective output matrix block, padding the remaining locations with another value. In an embodiment, the other value utilized is a zero which can be understood as a “bed of nails” filter. Specifically, the input value of the feature map data block 422 is transferred into the respective location 555 within the output data block 440. In these embodiments, the upsampling process will not be able to apply input values to any variable location within an output matrix block based on the original input data as that information was lost during the convolution process. Thus, as in the embodiment depicted in FIG. 5C, each input value from the input block (i.e. feature map) 420 can only be placed in the upper left pixel of the output data block 440. To overcome such an issue, the upsampling processes may acquire a second input that allows for location data (hereinafter “pooling” data) to be utilized in order to better generate an output matrix block (via “unpooling”) that better resembles or otherwise is more closely associated with the original input data compared to a static, non-variable filter, as is numerically illustrated in FIG. 5D.

FIG. 5 D is an illustrative numerical example of an upsampling process with a second input for unpooling in a neural network capable of performing the operations to transform input data to palette in accordance with an embodiment of the disclosure is shown. In some embodiments, the input data block 410 from the convolution processing earlier in the process can be utilized to provide positional information about the data. The input block 410 can be “pooled” in that the input block 410 stores the location of the originally selected maximum value from FIG. 4B. Then, utilizing a lateral connection to the upsampling process, the pooled data can be unpooled to indicate to the process (or filter) where the values in the input block (i.e., feature map) should be placed within each block of the unpooled output data block 550. Thus, the use of lateral connections can provide additional information for upsampling processing that would otherwise be unavailable, potentially reducing computational accuracy.

Although illustrative examples of an upsampling process suitable for carrying out the various steps, processes, methods, and operations described herein is discussed with respect to FIGS. 5A-5D, any of a variety of systems and/or processes may be utilized in accordance with embodiments of the disclosure. For example, the upsampling may be done on a numeric level but may also be based on various macro-elements such as colors, adjectives, and/or features. The elements depicted in FIGS. 5A-5D may also be interchangeable with other elements of FIGS. 1-4B and 6A-11 as required to realize a particularly desired embodiment.

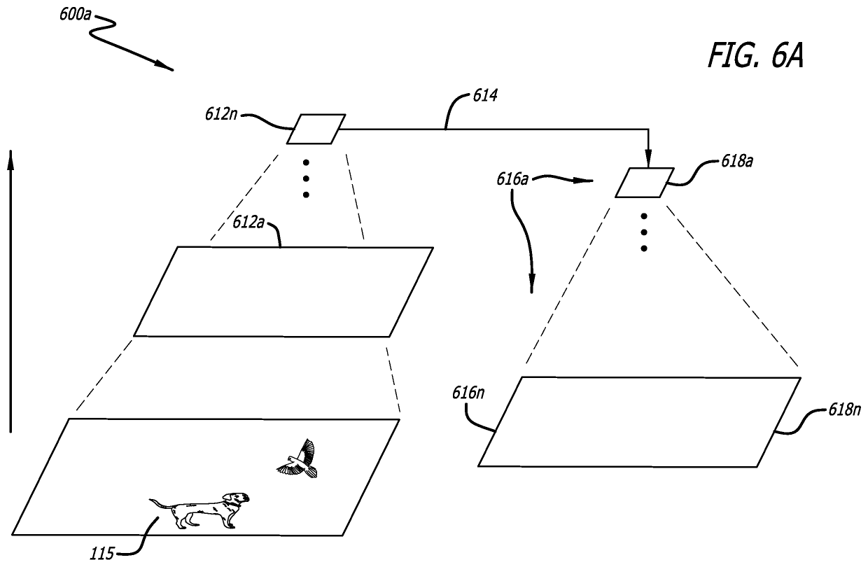

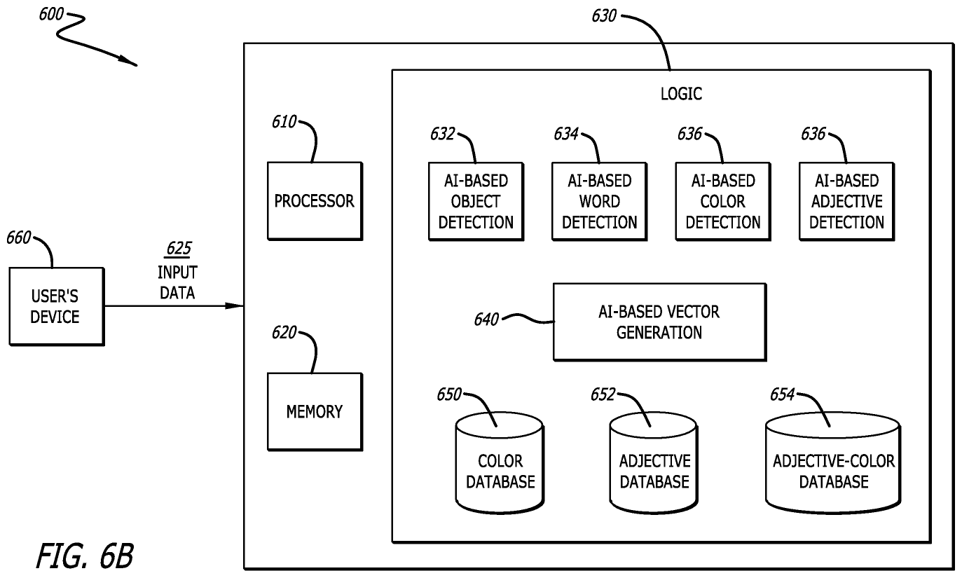

Referring to FIG. 6A now, a conceptual illustration of a feature pyramid network 600A in a neural network capable of performing the operations to transform input data to palette in accordance with an embodiment of the disclosure is shown. The feature pyramid network 600A can take input data such as an, but not limited to, image data and process the data, such as the input image 115 through a series of two “pathways.” The first pathway is a “convolution and pooling pathway” which comprises multiple downsampling steps. Conversely, the second pathway is known as an “upsampling pathway” which processes the input data from the multi-step convolution pathway through a series of upsampling steps. The feature pyramid network 600A can be configured to help detect objects in different scales within an image. Further configuration can provide feature extraction with increased accuracy and speed compared to alternative neural network systems. The first pathway comprises a series of convolution networks for feature extraction. As the convolution processing continues, the spatial resolution decreases, while higher level structures are better detected, and semantic value increases. The use of the second pathway allows for the generation of data corresponding to higher resolution layers from an initial semantic rich layer.

While layers reconstructed in the second pathway are semantically rich, the locations of any detected objects within the layers are imprecise due to the previous processing. Additional information can be added through the use of lateral connection 615 between one of a first layers to a corresponding second layer. A data pass layer 614 can pass the data from the last layer from the first path to the first layer of the second path. These lateral connection 615 help the feature pyramid network 600A generate output that predicts locations of objects within the input image 115.

The feature pyramid network of FIG. 6A can receive the input image 115 and processes it through one or more convolution filters to generate a first feature map layer 612a. The first feature map layer 612a is then itself processed through one or more convolution filters to generate a second feature map layer (not shown) which is itself further processed through more convolution filters to obtain a third feature map layer and so on. The feature pyramid network 600A can continue the convolution process until a final feature map layer 612n is generated. In some embodiments, the final feature map layer 612n may only be a single pixel or value. From there, the second process can begin by utilizing a first lateral connection to transfer a final feature map layer 612n for upsampling to generate a first upsampling output layer 616a. At this stage, it is possible for some data prediction to be generated relating to some detection within the first upsampling output layer 616a. Similar to the first process, the second process can continue processing the first upsampling output layer 616a through more upsampling processes to generate a second upsampling output layer which is also input into another upsampling process to generate a third upsampling output layer. This process continues until the final upsampling output layer 616n is the same, or similar size as the input image 115.

In an embodiment, at each step within the upsampling process, a lateral connection 615 can be utilized to add location or other data that was otherwise lost during the bottom-up processing. As the input is processed in the second steps, the output becomes more spatially accurate. By utilizing prediction data outputs such as the data prediction at the first upsampling layer 616a that are earlier within the second processing, the generation of desired data may occur earlier, requiring fewer processing operations and less computational power, saving computing resources. The decision to utilize earlier prediction outputs such as the data prediction at the first upsampling layer 616a can be based on the desired application and/or the type of input source material.

While the preceding sections encompass detailed descriptions regarding the structure and operations of the neural networks, following sections provide detailed descriptions of embodiments of the present disclosure in which the system for transforming input data to palettes using neural network 100, as shown in FIG. 1, can generate a palette based on an input data which can be an image, a textual phrase, etc.

Referring to FIG. 6B, a conceptual diagram of a system for transforming input data to palettes using neural network 600B is shown. The system for transforming input data to palettes using neural network 600B can include a processor 610, a memory 620 communicatively coupled to the processor 610, and a logic 630, such as an image to palette representation logic. The logic 630 can include an artificial intelligence (AI)-based object detection unit 632, an AI-based word detection unit 634, an AI-based color detection unit 636, an AI-based adjective detection unit 638, and an AI-based vector generation unit 640. The logic 630 can further include one or more databases including a color database 650, an adjective database 652 and an adjective-color database 654. In many embodiments, the AI-based object detection unit 632, the AI-based word detection unit 634, the AI-based color detection unit 636, the AI-based adjective detection unit 638, the AI-based vector generation unit 640, the color database 650, the adjective database 652 and the adjective-color database 654 are in communication with each other.

Further, although the logic 630 as illustrated in FIG. 6B, includes separate AI-based word detection unit 634, AI-based color detection unit 636, AI-based adjective detection unit 638, and AI-based vector generation unit 640, in various embodiments, one or more units can perform functions of two or more of other units. For example, the AI-based object detection unit 632 can perform the color detection and object detection tasks, and the AI-based adjective detection unit 638 can perform the adjective detection and the color-adjective detection tasks. Similarly, although three separate databases are illustrated in FIG. 6B, the logic 630 can include any number of databases. For example, in an embodiment, the logic 630 can include one database including colors, adjectives and adjective-color pairs. In some embodiments, the logic 630 can communicate with a user device 660. The user device 660 can be any suitable user device capable of communicating with the logic 630. For example, the user device 660 can be a desktop PC, a laptop, a smartphone, etc. The user device 660 can transmit an input data 625 to the system for transforming input data to palettes using neural network 600B.

The system for transforming input data to palettes using neural network 600B can further include a communication interface (not shown). The processor 610 may include one or more central processing units, one or more general-purpose processors, one or more application-specific processors, one or more virtual processors, one or more processor cores, or the like. In some embodiments, the logic 630 can receive the input data 625. The input data 625 can be transmitted via the user's device 660 in communication with the logic 630. As noted above, the user device 660 can be any suitable device capable of communicating with the logic 630 through the communication interface.

By employing the neural networks described in FIGS. 2-6A, the logic 630 can receive the input data and extract one or more features from the input data and generate the prediction data based on the extracted one or more features. In some embodiments, the input data can be an image. A user can transmit the image to the logic 630, which can display the final prediction data to the user. While the following sections describe operations that are performed by one of the AI-based object detection unit 632, the AI-based word detection unit 634, the AI-based color detection unit 634, the AI-based adjective detection unit 638, and the AI-based vector generation unit 640, one skilled in the art would understand that any of these operations can be performed by the logic 630 as well.

The AI-based object detection unit 632 can identify one or more objects in the image. To that end, the AI-based object detection unit 632 can use an object detection technique to detect the one or more objects, count the detected objects, and determine and track their precise locations, with or without need for labeling them. According to some embodiments, the object detection technique may make use of special and unique properties of each class of objects to identify the required object. For example, while looking for square shapes, the object detection technique can look for perpendicular corners that will result in the shape of a square, with each side having the same length. As another example, while looking for a circular object, the object detection technique may look for central points from which the creation of the particular round entity is possible.

According to another embodiment, the AI-based object detection unit 632 may extract the most essential features (e.g., 2000 features) by making use of selective features. To that end, a trained selective search algorithm can generate multiple sub-segmentations on the image. The selective search algorithm can then use a recurring process to combine the smaller segments into suitable larger segments. Subsequently, AI-based object detection unit 632 may extract the features and make the appropriate predictions. The AI-based object detection unit 632 can create an n-dimensional (e.g., 2208, 4096, etc.) feature vector as output based on final candidate. The final step can include making the appropriate predictions for the image and label the respective bounding box accordingly. In order to obtain the best results for each task, the predictions can be made by the computation of a classification model for each task, while a regression model is used to correct the bounding box classification for the proposed regions.

In some embodiments, the AI-based object detection unit 632 may use fixed size sliding windows, which slide from one side to another side (e.g., left-to-right and top-to-bottom) to localize objects at different locations. Then, the AI-based object detection unit 632 may proceed with forming an image pyramid to detect objects at varying scales, and performing a classification via a trained classifier. For example, at each stop of the sliding window and image pyramid, the AI-based object detection unit 632 may extract the region of interest, and feed it into the neural network to obtain the output classification for the region of interest. If the classification probability of label L is higher than a certain threshold, the AI-based object detection unit 632 can mark the bounding box of the region of interest as the label (L). Repeating this process for every stop of the sliding window and image pyramid, the AI-based object detection unit 632 can obtain the output object detectors. Finally, the AI-based object detection unit 632 can apply non-maxima suppression to the bounding boxes yielding the final output detections. In some embodiments, the AI-based object detection unit 632 can feed extracted features into a regression model that predicts the location of the object along with its label.

In an embodiment, in order to detect objects in the input data, the AI-based object detection unit 632 can draw bounding boxes around detected objects and locate where the objects are in. In some embodiments, AI-based object detection models are utilized to detect objects in the input data. Such AI-based models may have two main components. The first component is an encoder that takes the input data as input and runs it through a series of blocks and layers that learn to extract statistical features used to locate and label objects. Outputs from the encoder are then passed to the second component, which is a decoder that predicts bounding boxes and labels for each object. The decoder can be a regressor connected to the output of the encoder which predicts the location and size of each bounding box directly. The output of the model is the X, Y coordinate pair for the object and its extent in the input data.

The AI-based object detection unit 632 may further utilize an extension of a regressor including a region proposal network. Such a decoder can propose regions of the input data where an object may reside. The pixels belonging to these regions are then fed into a classification subnetwork to determine a label (or reject the proposal). The pixels containing those regions are then run through a classification network to propose arbitrary numbers of regions that may contain a bounding box.

In some embodiments, the AI-based object detection unit 632 can utilize single shot detectors, such as a non-maximum suppression. The single shot detector may rely on a set of predetermined regions. A grid of anchor points is laid over the input data, and at each anchor point, boxes of multiple shapes and sizes serve as regions. For each box at each anchor point, the AI-based object detection unit 632 can output a prediction of whether or not an object exists within the region and modifications to the box's location and size to make it fit the object more closely. In such embodiments, AI-based object detection unit 632 may skip splitting the input data into grids of arbitrary size but instead predict offset of predefined anchor boxes for every location of the feature map. Each box has a fixed size and position relative to its corresponding cell. All the anchor boxes tile the whole feature map in a convolutional manner. Feature maps at different levels may have different receptive field sizes. The anchor boxes on different levels may be rescaled so that one feature map is only responsible for objects at one particular scale.

The AI-based object detection unit 632 may further use metrics, such as intersection-over-union, to enhance accuracy of the predictions. Given two bounding boxes, the AI-based object detection unit 632 may compute the area of the intersection and divides by the area of the union, that ranges from 0 (no interaction) to 1 (perfectly overlapping). For labels, the system may use a distinct term, e.g., percent correct.

In some embodiments, the AI-based object detection unit 632 may skip the region proposal step and only predict over a limited number of bounding boxes. To that end, the AI-based object detection unit 632 may split the input data into S×S cells. If an object's center falls into a cell, that cell is “responsible” for detecting the existence of that object. Each cell predicts the location of bounding boxes (B), a confidence score, and a probability of object class conditioned on the existence of an object in the bounding box. The coordinates of bounding box can be defined by a tuple of 4 values, (center x-coordination, center y-coordination, width, height)−(x,y,w,h), where x and y are set to be offset of a cell location. Moreover, x, y, w and h are normalized by the input data width and height, and thus all between (0, 1]. A confidence score can be defined to indicate the likelihood that the cell contains an object. The confidence score can be a function of the probability and the interaction under union. If the cell contains an object, the AI-based object detection unit 632 can predict the probability of this object belonging to every class. At this stage, the AI-based object detection unit 632 can only predict one set of class probabilities per cell, regardless of the number of bounding boxes, B. Using this approach, the input data can contain S×S×B bounding boxes, each box corresponding to 4 location predictions, 1 confidence score, and K conditional probabilities for object classification. The total prediction values for one image is S×S×(5B+K), which is the tensor shape of the final conv layer of the neural network. The final layer of the trained neural network can be modified to output a prediction tensor of size S×S×(5B+K).

The logic 630 may further calculate a loss function. The loss can consist of two parts, the localization loss for bounding box offset prediction and the classification loss for conditional class probabilities. Both parts can be computed as the sum of squared errors. Two scale parameters can be used to control how much the loss from bounding box coordinate predictions should be increased and how much the loss of confidence score predictions for boxes without objects should be decreased.

In some embodiments, the AI-based color detection unit 634 can determine one or more colors for each of the identified objects. The determination of the colors can include detecting a list of the most important colors within the detected objects of the image. Such most important colors can include 3 types of colors: the dominant color, the accent colors, and the secondary colors. The dominant colors may be the colors that would be perceived as being the dominant one in the image by a human viewer and can take into account at least one of: the area covered by (i.e., comprised of) the color, the way this area is distributed in the image, and the intensity of the color as perceived by humans. For instance, highly saturated colors, or colors close to red/yellow/orange will stand out more than duller colors, which can be accounted for in the color detection.

Alternatively, the AI-based color detection unit 634 may detect accent color. Accent colors are colors that are not dominant in the image, that sometimes may occupy a small area of the image, but that still draw the human eye's due to their intensity, contrast or saturation. For example, in an image of a person wearing a red T-shirt, the red T-shirt, although small in area, may have an impactful color. In such a scenario, the AI-based color detection unit 634 may detect the red T-shirt as an accent color.

Finally, the AI-based color detection unit 634 can detect secondary colors. Secondary colors are colors that are important in the image but that are neither the dominant one nor accent colors. In various embodiments, the used can choose the secondary colors. Alternatively, the AI-based color detection unit 634 may determine that a specific color, which is neither a dominant nor an accent color, is important (e.g., an important object of the image comprises the color) and mark the color as one of the most important colors used to generate the palette representing the image.

In various embodiments, the AI-based color detection unit 634 can perform edge detection once or multiple times. In an embodiment, the AI-based color detection unit 634 performs the edge detection three times: at least once for red, at least one for green, and at least once for blue. The AI-based color detection unit 634 can fuse the output to form one edge map. Alternatively, the AI-based color detection unit 634 can use a multi-dimensional gradient method to detect colors.

In some embodiments, the logic 630 can identify one or more areas of each identified object that comprise each identified color. The logic 630 can determine boundaries of each object, as described above. By employing boundary detection, the logic 630 can find the boundaries between what humans would consider to be different objects or regions of the image. To improve the chance that an edge detection algorithm of the logic 630 will find an actual semantic boundary, the edge detector algorithm may be an average of multiple edge detector algorithms at different resolutions. In an embodiment, the average edge detector algorithm approach may give lower weight to edges that only appear at finer resolutions.

In some embodiments, the logic 630 can calculate a set of overall areas comprising each of the identified colors utilizing any suitable method and generate a vector associated with each area comprising a color in such a way that a length of the vector is proportional to the cross-section of the area that comprises the color. By adding the lengths of each vector that is associated with each color a total cross section of areas that includes each color can be calculated.

The logic 630 can generate a palette based on the calculated set of overall areas. Additionally, or in the alternative, the logic 630 can generate the palette based on the calculated set of overall vectors. Each vector may be represented as a combination of direction and magnitude. In various embodiments, in order to calculate the sum of two vectors, both vectors are so placed that the first end of both vectors, i.e., the origins of vectors, are located at a common point. A conventional vector summation formula, e.g., parallelogram law, can be used to calculate each of the set of overall vectors.

The logic 630 may generate more than one palette. As a non-limiting example, the image may include multiple dominant colors. In such instances, the number of colors that is included in the generated palette may be insufficient to show every dominant color. As another non-limiting example, the image may include several colors, with no dominant colors. As yet another non-limiting example, the user may request additional colors to be shown and/or suggested in the palette. In such instances, the palette may not be able to display all the dominant colors, each of the several colors, or the requested colors, respectively. Thus, additional palettes may be needed to be generated. To that end, logic 630 can define a “closeness ratio” based on a mathematical formula. For example, the closeness ratio can be defined as an inverse of a difference between the overall vector associated with the palette and the vector associated with the image. The logic 630 can then identify a set of colors that may be possible candidates to form the additional palette (e.g., colors selected by the user, dominant color not included in the first generated palette, etc.). The logic 630 then calculates the overall vector associated with the possible additional palette. The logic 630 can calculate the inverse of the difference between the vector associated with the image and the vector associated with the possible additional palette, i.e., the closeness ratio. If the closeness ratio exceeds a certain threshold, then the logic 630 can store the possible additional palette as an additional palette. Otherwise, if the closeness ratio does not exceed the threshold, then logic 630 can discard the possible additional palette. In various embodiments, the threshold can be determined by the user or the logic 630. For example, the threshold can be defined as a percentage (e.g., above 80%).

Although illustrative examples of pyramid networks and logics for transforming input data to palettes suitable for carrying out the various steps, processes, methods, and operations described herein is discussed with respect to FIGS. 6A-6B, any of a variety of systems and/or processes may be utilized in accordance with embodiments of the disclosure. For example, the logic 630 can be a specialized image to palette representation logic or incorporated into a specialized device or logic. The elements depicted in FIGS. 6A-6B may also be interchangeable with other elements of FIGS. 1-5D and 7-11 as required to realize a particularly desired embodiment.

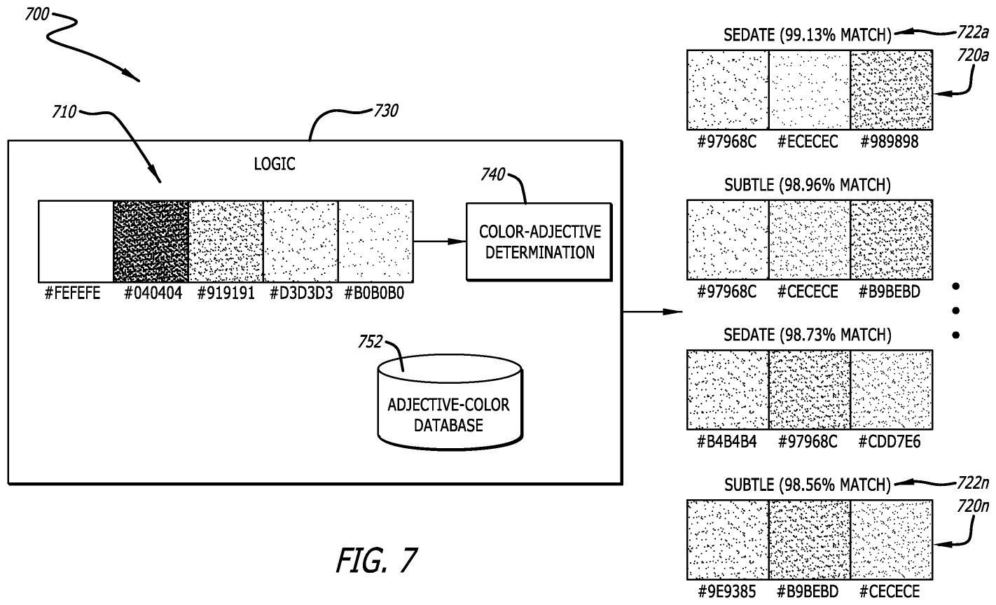

Referring to FIG. 7, a conceptual diagram 700 of a set of adjectives-palette pairs generated by the logic 730 is shown, according to some embodiments. In some embodiments, the AI-based color-adjective determination unit 740 of the logic 730 can further process the generated palette 710 and determine a set of adjective-palette pairs 720a, . . . , 720n. To that end, the AI-based color-adjective determination unit 740 can access the adjective-color database 752. Each adjective-color pair 720a, . . . , 720n can include the adjective 722a, . . . 722n. It is worth mentioning that several steps performed by the logic 730 in order to generate the adjective-palette pairs are similar to the operations described in preceding sections. In some embodiments, the logic 730 can receive a textual phrase as the input image 115 and parse the textual phrase to identify one or more words. The logic 730 can then generate a set of vector associated with each identified words. The logic 730 can calculate a second vector associated with the textual phrase based on a vector summation operation performed on the generated set of vectors. The logic 730 can generate a palette for the set of vectors and calculate a third overall vector associated with the palette. The logic 730 can define a second closeness ratio associated with the generated palette and determine whether the closeness ratio is larger than a second threshold. Then second closeness ratio can be defined in a same fashion as the first closeness ratio, with a difference that the second closeness ratio is defined as an inverse of a difference between the calculated second overall vector (often associated with the received phrase) and the calculated third overall vector.

The logic 730 can further access a database of pairs of colors and corresponding adjectives and determine an adjective for each colors of the palette. In some embodiments, the textual phrase can include more than one words. In such embodiments, logic 730 can identify each word of the textual phrase and assign a weight to each word. The assigned weight can be number between 0 and 1. The logic 730 can further generate a second set of vectors associated with each word and calculate a set of weighted vectors by applying the weights to the second set of vectors. The system for transforming input data to palettes using neural network can calculate a fourth overall vector associated with the identified words of the textual phrase based on a vector summation of the set of weighted vectors. By defining a third closeness ratio and determining whether the third closeness ratio associated with a palette is larger than a third threshold, the logic 730 can store the palette and display the stored palettes and their respective adjectives as the adjective-palette pairs representing the inputted textual phrase.

Further, in some embodiments, the logic 730 may identify one or more words in the received textual phrase. The logic 730 can further determine a set of words that are similar to each identified words. The logic 730 can generate a vector associated with each identified word and then find similar words with associated vectors with a closeness ratio that exceeds a threshold. The threshold can be selected by the user or calculated based on a mathematical formula and stored in the logic 730.

Alternatively, the logic 730 can access a database that includes words and their corresponding similar words. Each entry, i.e., word, in the database is associated with one or more other words. Each entry of the database is associated with a vector. Such as vector representation facilitates finding and associating entries, i.e., words, that are similar to each other. In determining similarity, the first entry's associated vector can be compared to the second entry's associated vector. Once the closeness ratio, i.e., the inverse of the difference between the corresponding associated vectors, exceeds a certain threshold, the logic 730 can associate the first entry and the second entry as similar to each other. For each entry, the logic 730 can further sort each corresponding similar word based on its closeness ratio. By sorting the corresponding similar words, the logic 730 can identify the similar words with highest closeness ratios, once the entry is detected in the received textual phrase.

For example, the logic 730 can receive a phrase and parse it to detect the word “attractive”, amongst other words. logic 730 can determine that “attractive” has corresponding similar words as “alluring”, “beautiful”, “charming”, “engaging”, “enticing”, “fair”, “glamorous”, “good-looking”, “gorgeous”, “handsome”, “interesting”, “inviting”, “lovely”, “pleasant”, “pleasing”, “tempting”, “adorable”, “agreeable”, “beckoning”, and “bewitching”. The logic 730 can access the vector associated with each of the corresponding similar words. Alternatively, the logic 730 can generate a vector associated with each of the corresponding similar words. Subsequently, the logic 730 can determine a closeness ratio for each of the corresponding similar words and the entry, i.e., “attractive”, by calculating the inverse of the different between the corresponding similar word and the entry and determine whether or not the calculated inverse of the difference between the corresponding similar words and the entry exceeds the threshold. The logic 730 can identify each corresponding similar word that meets the criterion, i.e., its closeness ratio exceeds the threshold, as a corresponding similar word for the entry.

Once the logic 730 determines the one or more words of the received textual phrase and their corresponding similar words, the logic 730 can calculate a weighted average vector associated with each of the one or more words. This process results in a vector associated with each identified word in the received phrase.

In some embodiments, the logic 730 then access a database including words and colors associated with each word and the identify a color associated with each of the identified words in the received phrase. The identified colors can be used to generate a palette. The logic 730 can display the generated palette to the user.

In some embodiments, the identified words in the received phrase may not exist in the database. The logic 730 can use the weighted vector associated with each identified word of the received phrase and access a database including words and colors associated with each word. The logic 730 can further generate a vector associated with each color of the database including words and colors associated with each word and determine whether the closeness ratio of each color and the identified word exceeds a certain threshold. That is, the logic 730 calculates the inverse of the different between the colors and the identified word and determine whether or not the calculated inverse of the difference between the colors and the identified word exceeds the threshold. The logic 730 can identify each color that meets the criterion, i.e., its closeness ratio exceeds the threshold, as a color corresponding to the identified word. The logic 730 can further generate a palette based on the determined colors corresponding to the identified words of the received phrase.

In some embodiments, the use of machine learning model can utilize these processes for various purposes including, but not limited to, interior design, etc. In further embodiments, the use of these processes can be utilized in mediums outside of images, such as, but not limited to, music, etc. In more embodiments, the generation of these palettes can be generated for utilization by individuals with one or more disabilities, such as colorblind people.

Although a specific embodiment for a process for detecting and processing movement anomalies suitable for carrying out the various steps, processes, methods, and operations described herein is discussed with respect to FIG. 7, any of a variety of systems and/or processes may be utilized in accordance with embodiments of the disclosure. For example, the match determination associated with adjectives can be compiled over two or more adjectives and/or developed based on different cultures or deployments. The elements depicted in FIG. 7 may also be interchangeable with other elements of FIGS. 1-6B and 8-11 as required to realize a particularly desired embodiment.

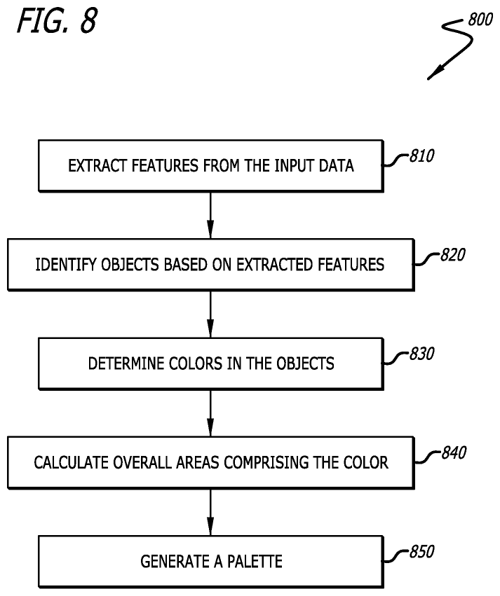

Referring to FIG. 8, a flowchart depicting a process 800 for generating a palette for an input data in accordance with an embodiment of the disclosure is shown. In many embodiments, the process 800 can first extract features from the input data, as shown in block 810. The process 800 can identify objects based on the extracted feature, as shown in block 820. The object identification process can be similar to the object detection methods described in previous sections. In particular, the object detection technique can include object detection models and neural networks.

In many embodiments, the process 800 can determine colors for each objects, as shown in block 830. The determination of the colors can include detecting a list of the most important colors within the detected objects of the image by performing edge detection. In additional embodiments, the process 800 can calculate overall areas comprising each color, as shown in block 840. Once the boundaries of each object are determined, the process 800 can calculate the area under the curve utilizing any suitable method. Alternatively, the process can generate a vector associated with each area comprising a color in such a way that a length of each vector is proportional to the cross section of the area that comprises the color. The process 800 can further add the lengths of each vector that is associated with each color, hence, calculating the total cross section of areas that includes each color. In some embodiments, the process 800 can generate a palette, as shown in block 850. In some embodiments, the process 800 can generate the palette based on the calculated set of overall areas or the calculated set of overall vectors.

Although a conceptual diagram of a set of adjectives generated by the logic suitable for carrying out the various steps, processes, methods, and operations described herein is discussed with respect to FIG. 8, any of a variety of systems and/or processes may be utilized in accordance with embodiments of the disclosure. For example, the objects in the image may be detected via a machine learning process but may be executed by a remote or cloud-based service. The elements depicted in FIG. 8 may also be interchangeable with other elements of FIGS. 1-7 and 9-10 as required to realize a particularly desired embodiment.

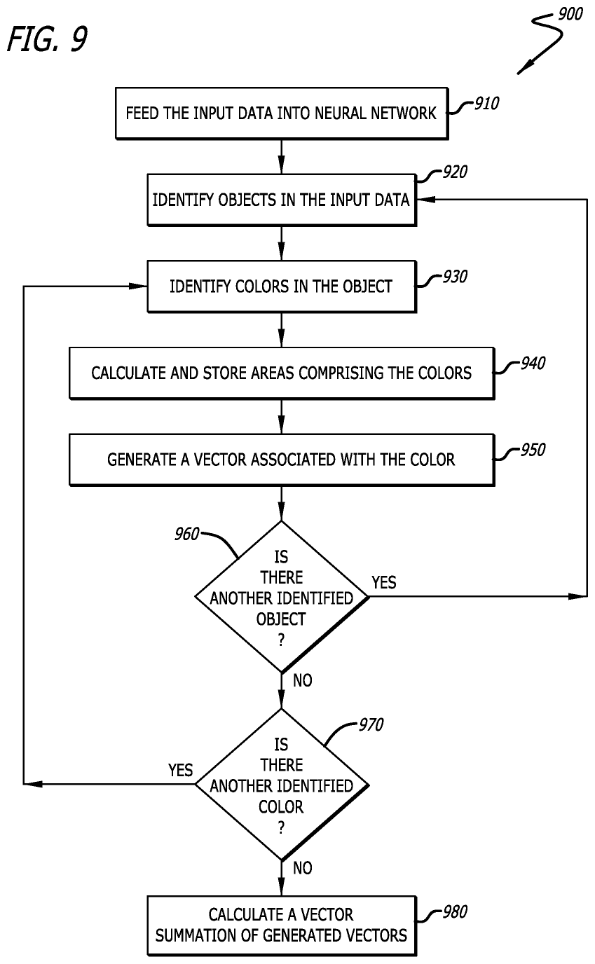

Referring to FIG. 9, a flowchart depicting a process 900 for calculating a vector summation for an input data in accordance with an embodiment of the disclosure is shown. In many embodiments, the process 900 can first feed the input data into the neural network, as shown in block 910. In some embodiments, the neural network-implemented process 900 can identify the objects in the input data, as shown in block 920. Identifying the objects in the input data can be performed similar to the object identification described in FIG. 8. The neural network-implemented process 900 can identify colors in the object, as shown in block 930. Identifying the colors in the input data can be performed similar to the object identification described in FIG. 8.

The neural network-implemented process 900 can proceed to calculate and store areas comprising the color, as shown in block 940. The neural network-implemented process 900 can identify boundaries of each object and then calculate the areas under the curve. The neural network-implemented process 900 can generate a vector associated with the color, as shown in block 950. As shown in block 960, the neural network-implemented process 900 can subsequently determine whether any additional object is identified in the input data, as shown in block 960. If there are additional objects identified in the input data, then the neural network-implemented process 900 moves to the next object and the neural network-implemented process 900 can start over from block 920. Once there is no additional identified object in the input data, the neural network-implemented process 900 can proceed to block 970, where the neural network-implemented process 900 can determine whether any additional color is identified in the input data. sum and store areas comprising the colors. If there are additional colors identified in the input data, then the neural network-implemented process 900 moves to the next color and the neural network-implemented process 900 can start over from block 930. Once there is no additional identified color in the input data, the neural network-implemented process 900 can proceed to block 980, where the neural network-implemented process 900 can calculate a vector summation of the generated vectors.

The neural network-implemented process 900 can add the lengths of each vector that is associated with each color to the total cross section of areas that includes each color. In various embodiments, in order to calculate the sum of two vectors, the neural network-implemented process 900 can place the vectors so the origins of vectors are located at a common point. The neural network-implemented process 900 then can add the vectors based on conventional vector summation formula, e.g., parallelogram law.

Although a conceptual diagram of a set of adjectives generated by the logic suitable for carrying out the various steps, processes, methods, and operations described herein is discussed with respect to FIG. 9, any of a variety of systems and/or processes may be utilized in accordance with embodiments of the disclosure. For example, other data associated with an image may be analyzed, including depth data, infrared data, or the like. The elements depicted in FIG. 9 may also be interchangeable with other elements of FIGS. 1-8 and 10-11 as required to realize a particularly desired embodiment.

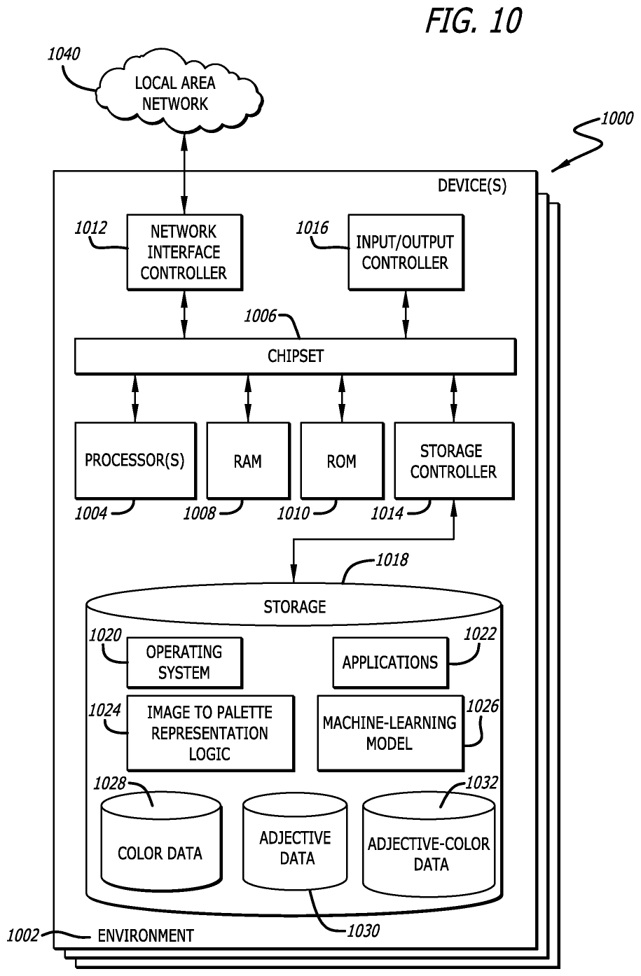

Referring to FIG. 10, a conceptual block diagram of a device suitable for configuration with a movement detection logic in accordance with various embodiments of the disclosure is shown. The embodiment of the conceptual block diagram depicted in FIG. 10 can illustrate a conventional server computer, workstation, desktop computer, laptop, tablet, network device, access point, router, switch, e-reader, smart phone, centralized management service, or other computing device, and can be utilized to execute any of the application and/or logic components presented herein. The device 1000 may, in some examples, correspond to physical devices and/or to virtual resources and embodiments described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002. The chipset 1006 can provide an interface to communicatively couple a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, applications 1022, and data 1028, 1030, 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiment, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-10. In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many embodiments, the device 1000 can include an image to palette representation logic 1024 that can be configured to perform one or more of the various steps, processes, operations, and/or other methods that are described above. While the embodiment shown in FIG. 10 depicts a logic focused on network capacity, it is contemplated that a more general “network needs” logic may be utilized as well or in lieu of such logic. Often, the image to palette representation logic 1024 can be a set of instructions stored within a non-volatile memory that, when executed by the controller(s)/processor(s) 1004 can carry out these steps, etc. In some embodiments, the image to palette representation logic 1024 may be a client application that resides on a network-connected device, such as, but not limited to, a server, switch, personal or mobile computing device in a single or distributed arrangement. In certain embodiments, the image to palette representation logic 1024 can be a dedicated hardware device or be configured into a system on a chip package (FPGA, ASIC and the like).

In a number of embodiments, the storage 1018 can include color data 1028. As discussed above, the color data 1028 can be collected in a variety of ways and may involve data related to multiple images. The color data 1028 may be associated with an entire image or a portion/partition of an image. This may also include a relationship of the various associated images that are associated with each other. In additional embodiments, the color data 1028 can include not only color-related data, but may also include details about the metadata, color-coding, device hardware configuration and/or capabilities of the devices within the image processing pipeline. This can allow for more reliable adjective and/or palette determinations.

In various embodiments, the storage 1018 can include adjective data 1030. As described above, adjective data 1030 can be configured to include various adjectives, as well as previously determined adjective associations. The adjective data 1030 may be formatted to store a range of values for each type of adjective. These adjectives can be utilized to compare against current values or images. This adjective data 1030 can be provided by a provider prior to deployment. However, system administrators may train or otherwise associate these values by utilizing feedback on correct and incorrect detected relationships.

In still more embodiments, the storage 1018 can include adjective-color data 1032. As discussed above, adjective-color data 1032 can be utilized to verify the relationship between an adjective and a color. Likewise, by utilizing adjective-color data 1032, the type of associations may be better discerned. Likewise, one or more palettes may be generated by utilizing the adjective-color data 1032.

Finally, in many embodiments, data may be processed into a format usable by a machine-learning model 1026 (e.g., feature vectors, etc.), and or other pre-processing techniques. The machine learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to learn the pattern of historical movement data of various network devices and generate predictions and/or confidence levels regarding current anomalous movements. In some embodiments, the ML model 1026 can be configured to determine various adjective and color relationships to generate a palette related to an image as well as parsing out various object and/or portions of the images.

The ML model(s) 1026 can be configured to generate inferences to make predictions or draw conclusions from data. An inference can be considered the output of a process of applying a model to new data. This can occur by learning from at least the topology data, historical data, measurement data, profile data, neighboring device data, and/or the underlying algorithmic data and use that learning to predict future outcomes and needs. These predictions are based on patterns and relationships discovered within the data. To generate an inference, such as a determination on anomalous movement, the trained model can take input data and produce a prediction or a decision/determination. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes. The training set of the ML model(s) 1026 can be provided by the manufacturer prior to deployment and can be based on previously verified data.

Although a specific embodiment for a device suitable for configuration with a network capacity prediction logic suitable for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or APs such that each acts as a device and the image to palette representation logic 1024 acts in tandem between the devices. The elements depicted in FIG. 10 may also be interchangeable with other elements of FIGS. 1-9 and 11 as required to realize a particularly desired embodiment.

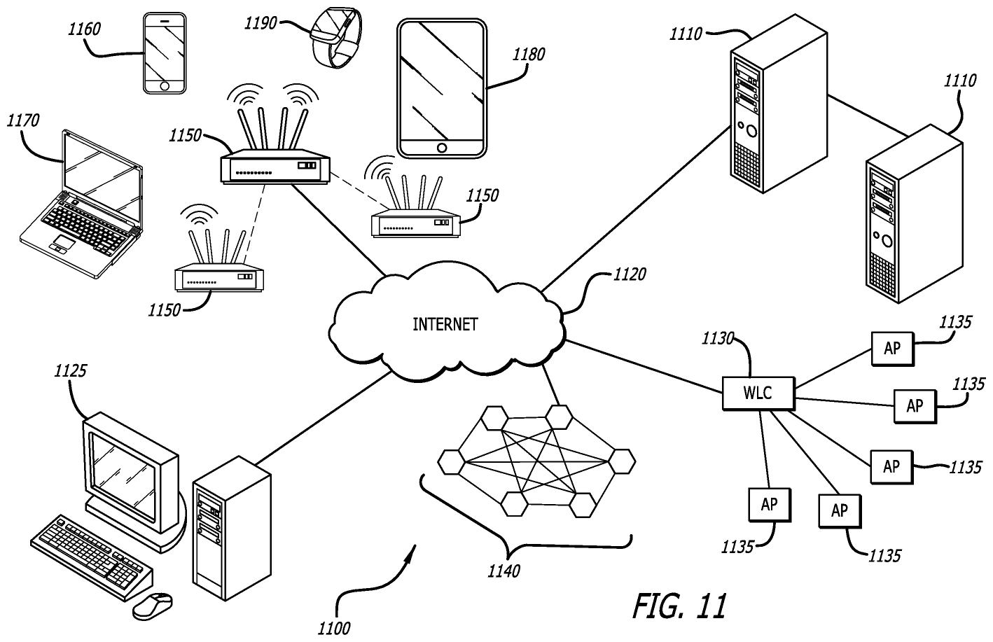

Referring to FIG. 11, a conceptual network diagram of various environments that a image to palette representation logic may operate within in accordance with various embodiments of the disclosure in accordance with various embodiments of the disclosure is shown. Those skilled in the art will recognize that an image to palette representation logic can be comprised of various hardware and/or software deployments and can be configured in a variety of ways. In some non-limiting examples, the image to palette representation logic can be configured as a standalone device, exist as a logic within another network device, be distributed among various network devices operating in tandem, or remotely operated as part of a cloud-based network management tool.

In many embodiments, the network 1100 may comprise a plurality of devices that are configured to transmit and receive data for a plurality of clients. In various embodiments, cloud-based centralized management servers 1110 are connected to a wide-area network such as, for example, the Internet 1120. In further embodiments, cloud-based centralized management servers 1110 can be configured with or otherwise operate a image to palette representation logic. The image to palette representation logic can be provided as a cloud-based service that can service remote networks, such as, but not limited to the deployed network 1140. In these embodiments, the image to palette representation logic can be a logic that receives data from the deployed network 1140 and generates predictions, receives environmental sensor signal data, and perhaps automates certain decisions or protective actions associated with the network devices. In certain embodiments, the image to palette representation logic can generate historical and/or algorithmic data in various embodiments and transmit that back to one or more network devices within the deployed network 1140.

However, in additional embodiments, the image to palette representation logic may be operated as distributed logic across multiple network devices. In the embodiment depicted in FIG. 11, a plurality of network access points (APs) 1150 can operate as a image to palette representation logic in a distributed manner or may have one specific device facilitate the detection of movement for the various APs. This can be done to provide sufficient needs to the network of APs such that, for example, a minimum bandwidth capacity may be available to various devices. These devices may include but are not limited to mobile computing devices including laptop computers 1170, cellular phones 1160, portable tablet computers 1180 and wearable computing devices 1190.

In still further embodiments, the image to palette representation logic may be integrated within another network device. In the embodiment depicted in FIG. 11, the wireless LAN controller 1130 may have an integrated image to palette representation logic that it can use to generate predictions, and perhaps detect anomalous movements regarding the various APs 1135 that it is connected to, either wired or wirelessly. In this way, the APs 1135 can be configured such that they can process image and/or palette related data. In still more embodiments, a personal computer 1125 may be utilized to access and/or manage various aspects of the image to palette representation logic, either remotely or within the network itself. In the embodiment depicted in FIG. 11, the personal computer 1125 communicates over the Internet 1120 and can access the image to palette representation logic within the cloud based centralized management servers 1110, the network APs 1150, or the WLC 1130 to modify or otherwise monitor the image to palette representation logic.

Although a specific embodiment for a conceptual network diagram of a various environments that an image to palette representation logic operating on a plurality of network devices suitable for carrying out the various steps, processes, methods, and operations described herein is discussed with respect to FIG. 11, any of a variety of systems and/or processes may be utilized in accordance with embodiments of the disclosure. For example, the image to palette representation logic may be implemented across a variety of the systems described herein such that some detections are generated on a first system type (e.g., remotely), while additional detection steps or protection actions are generated or determined in a second system type (e.g., locally). The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
an image to palette representation logic comprising a neural network configured to receive an input data to generate prediction data, the neural network comprising:
a multi-step convolution pathway comprising a plurality of convolution steps;
a multi-step upsampling pathway comprising a plurality of upsampling steps, wherein the plurality of upsampling steps comprises an input to receive output data from a corresponding convolution pathway step; and
wherein, in response to receiving the input data, feature map output data is generated at the plurality of convolution steps, and at least one step of the plurality of upsampling steps utilizes at least the generated feature map data to generate prediction data;
wherein the neural network is further configured to:
extract one or more features from the input data; and
generate the prediction data based on the extracted one or more features.

2. The device of claim 1, wherein the neural network is configured to display the generated prediction data to a user.

3. The device of claim 2, wherein the input data is an image and is received from the user.

4. The device of claim 3, wherein the neural network is configured to:
identify one or more objects in the image;
determine one or more colors for each identified object;
calculate a set of overall areas comprising the one or more determined colors; and
generate a palette based on the calculated set of overall areas.

5. The device of claim 4, wherein the neural network is further configured to:
generate a vector associated with each of the one or more colors, wherein a length of the vector is indicative of a cross-section of an area comprising each of the one or more colors; and
calculate the set of overall areas by adding lengths of each generated vector.

6. The device of claim 4, wherein the neural network is configured to:
calculate a first overall vector associated with the image based on a vector summation of the set of overall areas;
calculate a vector summation for the palette; and
in response to a first determination that a first closeness ratio associated with the palette is larger than a first predetermined threshold, store the palette, wherein the first closeness ratio is defined as an inverse of a difference between the calculated vector summation of the palette and the calculated first overall vector.

7. The device of claim 1, wherein the input data is a phrase.

8. The device of claim 7, wherein the neural network is further configured to:
identify one or more words in the phrase;
generate a set of vectors associated with each identified words;
calculate a second overall vector associated with the received phrase based on a vector summation of the generated set of vectors;
generate a palette for a set of colors comprising a predefined number of colors;
calculate a third overall vector associated with the palette based on a vector summation of the set of colors; and
in response to a second determination that a second closeness ratio associated with the generated palette is larger than a second predetermined threshold, store the generated palette, wherein the second closeness ratio is defined as an inverse of a difference between the calculated second overall vector and the calculated third overall vector.

9. The device of claim 8, wherein a user selects the predefined number of colors.

10. The device of claim 8, wherein the neural network is configured to:
access a database comprising pairs of colors and corresponding adjectives; and
determine an adjective for each of the set of colors of the generated palette.

11. The device of claim 8, wherein the neural network is configured to:
parse the received phrase to identify a set of words;
assign a weight to each of the identified words, wherein the assigned weight is a number between 0 and 1;
generate a second set of vectors associated with each of the identified words;
calculate a set of weighted vectors by applying the assigned weight to the associated identified word; and
calculate a fourth overall vector associated with the identified set of words based on the vector summation of the calculated set of weighted vectors.

12. The device of claim 11, wherein the neural network is configured to in response to a third determination that a third closeness ratio associated with the generated palette is larger than a third predetermined threshold, store the generated palette, wherein the third closeness ratio is defined as an inverse of a difference between the calculated third overall vector and the calculated fourth overall vector.

13. The device of claim 12, wherein a user selects the assigned weights.

14. A method, comprising:
configuring a neural network to receive input data to generate prediction data;
generating a multi-step convolution comprising a plurality of convolution steps;
generating a multi-step upsampling pathway comprising a plurality of upsampling steps, wherein the plurality of upsampling steps comprises an input to receive output data from a corresponding convolution pathway step;
wherein, in response to receiving the input data, feature map output data is generated at the plurality of convolution steps, and at least one step of the plurality of upsampling steps utilizes at least the generated feature map data to generate prediction data; and
configuring the neural network to:
extract one or more features from the input data; and
generate the prediction data based on the extracted one or more features.

15. The method of claim 14, further comprising configuring the neural network to:
identify one or more objects in the input data, wherein the input data is an image;
determine one or more colors for each identified object;
calculate a set of overall areas comprising the one or more determined colors; and
generate a palette based on the calculated set of overall areas.

16. The method of claim 15, further comprising configuring the neural network to:
generate a vector associated with each of the one or more colors, wherein a length of the vector is indicative of a cross-section an area comprising each of the one or more colors; and
calculate the set of overall areas by adding lengths of each generated vector.

17. The method of claim 15, further comprising configuring the neural network to:
calculate a first overall vector associated with the image based on a vector summation of the set of overall areas;
calculate a vector summation for the palette; and
in response to a first determination that a first closeness ratio associated with the palette is larger than a first predetermined threshold, store the palette, wherein the first closeness ratio is defined as an inverse of a difference between the calculated vector summation of the palette and the calculated first overall vector.

18. The method of claim 14, further comprising configuring the neural network to:
receive the input data comprising a phrase;
identify one or more words in the phrase;
generate a set of vectors associated with each identified words;
calculate a second overall vector associated with the received phrase based on a vector summation of the generated set of vectors;
generate a palette for a set of colors comprising a predefined number of colors;
calculate a third overall vector associated with the palette based on a vector summation of the set of colors; and
in response to a second determination that a second closeness ratio associated with the generated palette is larger than a second predetermined threshold, store the generated palette, wherein the second closeness ratio is defined as an inverse of a difference between the calculated second overall vector and the calculated third overall vector.

19. The method of claim 18, further comprising configuring the neural network to:
assign a weight to each of the identified words, wherein the assigned weight is a number between 0 and 1;
generate a second set of vectors associated with each of the identified words;
calculate a set of weighted vectors by applying the assigned weight to the associated identified word; and
calculate a fourth overall vector associated with the identified set of words based on the vector summation of the calculated set of weighted vectors.

20. A system, comprising:
one or more devices;
one or more processors coupled to the one or more devices; and
a non-transitory computer-readable storage medium comprising a neural network configured to receive an input data to generate prediction data, the neural network comprising:
a multi-step convolution pathway comprising a plurality of convolution steps;
a multi-step upsampling pathway comprising a plurality of upsampling steps, wherein the plurality of upsampling steps comprises an input to receive output data from a corresponding convolution pathway step; and
wherein, in response to receiving the input data, feature map output data is generated at the plurality of convolution steps, and at least one step of the plurality of upsampling steps utilizes at least the generated feature map data to generate prediction data;
wherein the neural network is further configured to:
extract one or more features from the input data; and
generate the prediction data based on the extracted one or more features.
